(19) United States
(12) Patent Application Publication
(10) Pub. No.: US 2006/0133017 A1
(43) Pub. Date: Jun. 22, 2006

(54) Chassis base assembly, method of manufacturing the chassis base assembly and plasma display panel (PDP) assembly using the chassis base assembly

(76) Inventor: Won-Kyu Bang, Suwon-si (KR)

Correspondence Address: Robert E. Bushnell, Suite 300, 1522 K Street, N.W., Washington, DC, 20005-1202, US

(21) Appl. No.: 11/283,795

(22) Filed: Nov. 22, 2005

(30) Foreign Application Priority Data
Dec. 17, 2004 (KR) 10-2004-0108073

(51) Int. Cl. G06F 1/16

(52) U.S. Cl. 361/681

(57) ABSTRACT

In a chassis base assembly, a method of manufacturing the chassis base assembly, and a Plasma Display Panel (PDP) assembly, the method includes: preparing a raw flat panel for forming the chassis reinforcing member; forming ribs having a predetermined depth by processing the raw flat panel for forming the chassis reinforcing member using a drawing process; and forming an outer shape of the chassis reinforcing member using a notching process. There are no disconnections at corners where the horizontal and vertical reinforcing members meet to each other since the chassis reinforcing members are formed as a unitary body by a drawing process. Accordingly, stress concentrations at corners of the chassis reinforcing members are prevented, thereby increasing the strength of the chassis base assembly.

### CLAIM OF PRIORITY

This application makes reference to, incorporates the same herein, and claims all benefits accruing under 35 U.S.C. § 119 from an application for CHASSIS BASE ASSEMBLY, THE FABRICATION METHOD THEREOF, AND PLASMA DISPLAY PANEL ASSEMBLY USING THE SAME earlier filled in the Korean Intellectual Property Office on 17 Dec. 2004 and there duly assigned Serial No. 10-2004-0108073.

### BACKGROUND OF THE INVENTION

1. Field of the Invention

The present invention relates to a chassis base assembly and a Plasma Display Panel (PDP) assembly using the chassis base assembly, and more particularly, to a chassis base assembly in which a reinforcing member is formed in one body using a drawing process to increase the strength of the chassis base and a PDP assembly using the chassis base assembly.

2. Description of the Related Art

Plasma Display Panel (PDP) assembly is a flat display device that displays images using light emitted from an excited fluorescent material layer arranged in a discharge space filled with a discharge gas when ultraviolet rays are generated by supplying a predetermined voltage to discharge electrodes arranged on each of a plurality of substrates facing each other.

The PDP assembly is manufactured by assembling separately manufactured front and rear panels, attaching a chassis base assembly on a rear surface of the PDP assembly, mounting a driving circuit unit that transfers electrical signals to the PDP assembly on a surface of the chassis base assembly, and mounting these assembled elements in a case.

A chassis base assembly includes a chassis base and first and second chassis reinforcing members attached to a rear surface of the chassis base.

The first and second chassis reinforcing members are attached to the chassis base to reinforce the strength of the chassis base. The first chassis reinforcing members are horizontally attached to upper and lower ends of a rear surface of the chassis base and the second chassis reinforcing members are vertically attached to left and right ends of the rear surface of the chassis base. Each of the first and second chassis reinforcing members is respectively formed in a strip shape and independently attached to the chassis base.

Each first chassis reinforcing member includes a first rib having a strip shape and a first flange bent from both ends of the first rib, and each second chassis reinforcing member includes a second rib having a strip shape and a second flange bent from both ends of the second rib. The first and second chassis reinforcing members and 130 are fixedly attached to the rear surface of the chassis base by screws.

However, the chassis base assembly has the following problems.

The first chassis reinforcing member and the second chassis reinforcing member are separated from each other and respectively have a strip shape. Adjacent potions between the first and second chassis reinforcing members are not connected to each other. Therefore, the unconnected adjacent corners are weak with respect to withstanding concentrated stress and twisting deformations.

To avoid this problem, a horizontal chassis base reinforcing member and a vertical chassis base reinforcing member are formed into a unitary body chassis reinforcing member, and the unitary body chassis reinforcing member is affixed to the rear surface of the chassis base using screws.

However, in this case, ribs of uniform height at the corners where the horizontal chassis reinforcing member meets the vertical chassis reinforcing member can not be maintained. This problem is caused by the method of processing the unitary body chassis reinforcing member. That is, a flange of the chassis reinforcing member is disconnected at the portion where the horizontal chassis reinforcing member meets the vertical chassis reinforcing member when the chassis base is processed.

The disconnection of the flange and non-uniform rib height are caused because a bending process for forming the rib is performed with respect to the whole chassis reinforcing member, in which the horizontal chassis reinforcing member and the vertical chassis reinforcing member are formed as a unitary body, after blanking and notching processes are performed.

### SUMMARY OF THE INVENTION

The present invention provides a chassis base assembly that increases the strength of a chassis base by preventing the stress concentration on corners where horizontal and vertical chassis reinforcing members meet by forming a unitary body reinforcing member on a surface of the chassis base using a drawing process, and a PDP assembly using the chassis base assembly.

According to one aspect of the present invention, a chassis base assembly is provided including: a chassis base attached to a panel assembly adapted to display an image; and a unitary chassis reinforcing member arranged on a surface of the chassis base.

The unitary chassis reinforcing member preferably includes a plurality of connected strips arranged along horizontal and vertical directions of the chassis base. The unitary chassis reinforcing member preferably includes strip shaped ribs and flanges contacting an outer surface of the chassis base by extending downward from edges of the ribs. The unitary chassis reinforcing member preferably includes a drawn member.

According to another aspect of the present invention, a plasma display assembly is provided including: a panel assembly having a front panel and a rear panel facing the front panel; a chassis base adapted to support the panel assembly; a drawn unitary chassis reinforcing member attached to a surface of the chassis base; a driving circuit unit attached to the chassis base; a plurality of flexible printed cables each including one end thereof being electrically connected to respective electrode terminals of the panel assembly and another end thereof being electrically connected to a connector of the driving circuit unit, the plurality of flexible printed cables being adapted to transfer electrical signals therebetween; and a case adapted to accommodate the panel assembly, the chassis base, the driving circuit unit, and the plurality of flexible printed cables.

The unitary chassis reinforcing member preferably includes a plurality of connected strips arranged along horizontal and vertical directions of the chassis base. The unitary chassis reinforcing member preferably includes ribs protruded toward the driving circuit unit from an outer surface of the chassis base and flanges contacting an outer surface of the chassis base by extending from an edge of the ribs.

According to still another aspect of the present invention, a method of manufacturing a chassis base assembly is provided, the method including: preparing a raw flat panel for forming the chassis reinforcing member; forming ribs having a predetermined depth by processing the raw flat panel for forming the chassis reinforcing member using a drawing process; and forming an outer shape of the chassis reinforcing member using a blanking process.

According to yet another aspect of the present invention, a method of manufacturing a chassis base assembly is provided, the method including: preparing a raw flat panel for forming the chassis reinforcing member; forming ribs having a predetermined depth by processing the raw flat panel for forming the chassis reinforcing member using a drawing process; and forming an outer shape of the chassis reinforcing member using a notching process.

The forming of the ribs having a predetermined depth by processing the raw flat panel using a drawing process preferably includes connecting the chassis reinforcing members to each other to form a unitary body along horizontal and vertical directions of the chassis base.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a plan view of a chassis base assembly;

FIG. 2 is an enlarged view of region “A” of FIG. 1;

FIG. 3 is an exploded perspective view of a PDP assembly according to an embodiment of the present invention;

FIG. 4 is a perspective view of a chassis base assembly according to an embodiment of the present invention; and

FIG. 5 is an enlarged view of region “B” of FIG. 4.

### DETAILED DESCRIPTION OF THE INVENTION

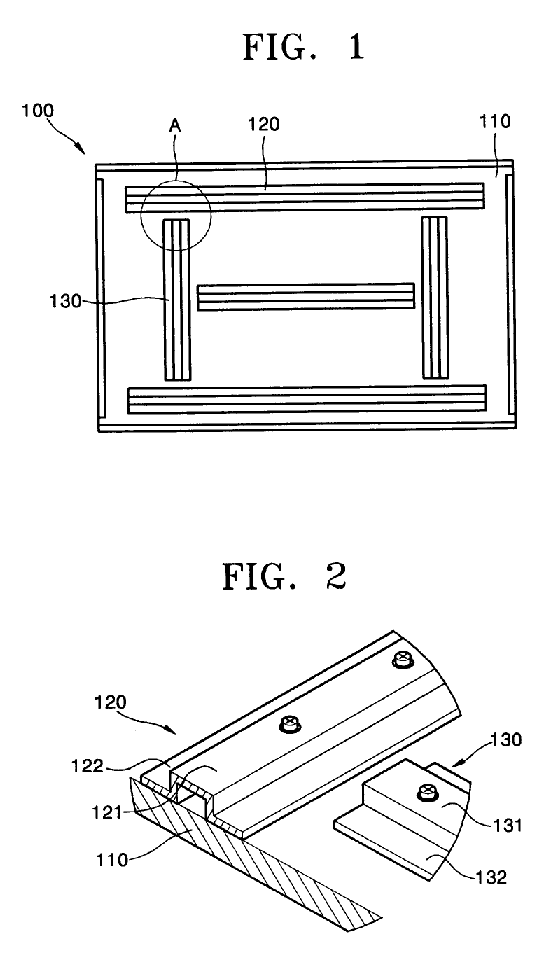

Referring to FIG. 1, a chassis base assembly 100 includes a chassis base 110 and first and second chassis reinforcing members 120 and 130 attached to a rear surface of the chassis base 110.

The first and second chassis reinforcing members 120 and 130 are attached to the chassis base 110 to reinforce the strength of the chassis base 110. The first chassis reinforcing members 120 are horizontally attached to upper and lower ends of a rear surface of the chassis base 110 and the second chassis reinforcing members 130 are vertically attached to left and right ends of the rear surface of the chassis base 110. Each of the first and second chassis reinforcing members 120 and 130 is respectively formed in a strip shape and independently attached to the chassis base 110.

Referring to FIG. 2, each first chassis reinforcing member 120 includes a first rib 121 having a strip shape and a first flange 122 bent from both ends of the first rib 121, and each second chassis reinforcing member 130 includes a second rib 131 having a strip shape and a second flange 132 bent from both ends of the second rib 131. The first and second chassis reinforcing members 120 and 130 are fixedly attached to the rear surface of the chassis base 110 by screws.

However, the chassis base assembly 100 has the following problems.

The first chassis reinforcing member 120 and the second chassis reinforcing member 130 are separated from each other and respectively have a strip shape. Adjacent potions between the first and second chassis reinforcing members 120 and 130 are not connected to each other. Therefore, the unconnected adjacent corners are weak with respect to withstanding concentrated stress and twisting deformations.

A Plasma Display Panel (PDP) assembly according to the present invention is described more fully below with reference to the accompanying drawings in which exemplary embodiments of the present invention are shown.

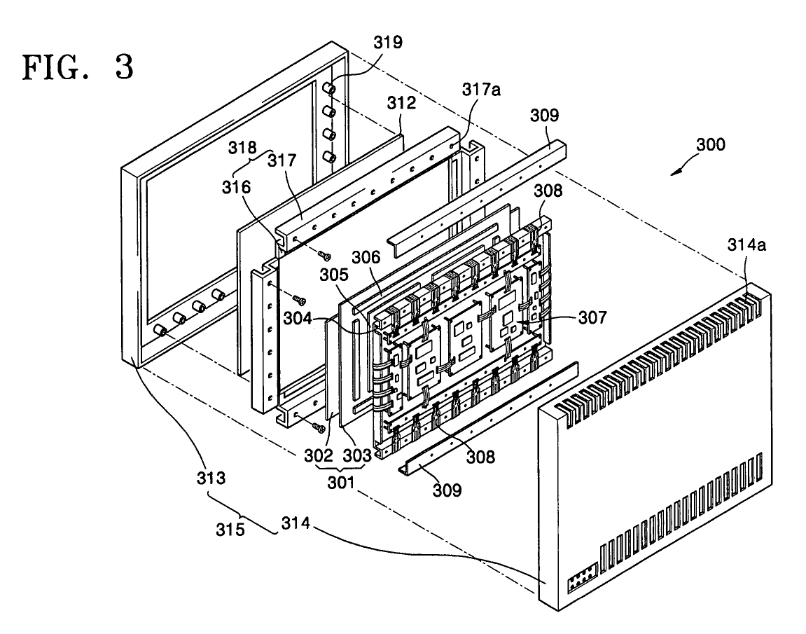

FIG. 3 is an exploded perspective view of a PDP assembly 300 according to an embodiment of the present invention.

Referring to FIG. 3, the PDP assembly 300 includes a front panel 302 and a panel assembly 301 having a rear panel 303 facing the front panel 302. A space between the front panel 302 and the rear panel 303 is sealed by frit glass coated along inner edges of the facing front panel 302 and the rear panel 303.

When the panel assembly 301 is a three-electrode surface discharge PDP, the front panel 302 is a transparent substrate formed of soda lime glass. A plurality of discharge sustain electrode pairs are included on an inner side of the front panel 302 and the discharge sustain electrode pairs are covered by a front dielectric layer. A protection film layer, formed of an oxide, such as MgO, is deposited on a surface of the front dielectric layer.

A rear substrate is included in the rear panel 303. The rear substrate includes address electrodes extending in a direction crossing the discharge sustain electrode pairs. The address electrodes are covered by a rear dielectric layer.

Barrier ribs that define discharge spaces are formed between the front panel 302 and the rear panel 303. The barrier ribs are a matrix type, a meander type, a honeycomb type, or a strip type. Fluorescent layers of red, green, and blue colors are coated on an inner surface of the barrier ribs. A discharge gas, such as Ne—Xe or He—Xe, is contained within the discharge cells defined by the front and rear panels 302 and 303 and the barrier ribs.

A chassis base assembly 304 is disposed on a rear side of the panel assembly 301. The chassis base assembly 304 is attached to the panel assembly 301 by an adhesion member. The adhesion member includes a heat radiation sheet 305 attached to a central portion of the rear surface of the rear panel 303 and a double-sided tape 306 attached to edges of the rear surface of the rear panel 303. The heat radiation sheet 305 can dissipate heat generated by the panel assembly 301 to the outside.

A driving circuit unit 307 is mounted on a rear surface of the chassis base assembly 304. The driving circuit unit 307 includes a plurality of circuit devices and flexible printed cables 308 connected to the driving circuit unit 307. The flexible printed cables 308 transfer electrical signals between each of the terminals of the panel assembly 301 and the driving circuit unit 307.

A filter assembly 312 is mounted on a front side of the panel assembly 301. The filter assembly 312 is installed to block electromagnetic waves or infrared rays generated by the operating panel assembly 301 or to block the reflection of external light.

For this purposes, the filter assembly 312 includes: a reflection prevention film for preventing the reduction of visibility of the transparent substrate due to the reflection of external light; an electromagnetic wave shielding layer for shielding the electromagnetic waves generated by the operating panel assembly 301; and a selective wave absorption film for blocking near infrared rays unnecessarily emitted by plasma of inert gas used for neon light 6 emission and screen light emission.

The panel assembly 301, the chassis base assembly 304, and the filter assembly 312 are accommodated in a case 315. The case 315 is composed of a front cabinet 313 mounted on a front side of the filter assembly 312 and a back cover 314 mounted on a rear side of the driving circuit unit 307. A vent hole 314a is formed in a lower part of the back cover 314.

A filter holder 318 is mounted on a rear surface of the filter assembly 312. The filter holder 318 includes a press portion 316 that presses the filter assembly 312 with respect to the front cabinet 313 and a fixing portion 317 bent backward from the press portion 316. The fixing portion 317 includes a plurality of coupling holes 317a.

A filter mounting unit 319 is formed on a rear surface of the front cabinet 313. The filter mounting unit 319 faces the fixing portion 317 and fixes the filter assembly 312 with respect to the front cabinet 313 by screws.

A chassis reinforcing member for preventing the chassis base from deforming due to a large size of the PDP is attached to a surface of the chassis base assembly. The chassis reinforcing member is formed by a drawing process.

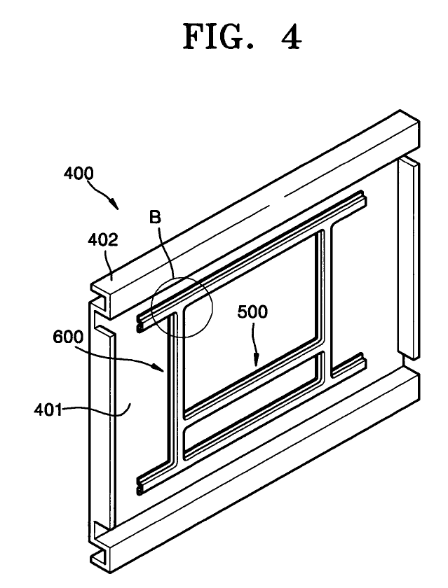

FIG. 4 is a perspective view of a chassis base assembly 400 according to an embodiment of the present invention.

Referring to FIG. 4, a main body unit 401 of a plane shape is part of the chassis base assembly 400. An edge 402 of the main body unit 401 is bent at least once to reinforce the main body unit 401 in consideration of attachment to a PDP assembly, a cover plate, or a flexible printed cable.

A first chassis reinforcing member 500 in a strip shape is attached close to both edges in a horizontal direction of a rear surface of the main body unit 401. Also, a second chassis reinforcing member 600 is attached close to both edges in a vertical direction of the rear surface of the main body unit 401. The first and second chassis reinforcing members 500 and 600 can be selectively attached to the chassis at a location where the strength of the chassis base is weak due to the large size of the PDP.

The first and second chassis reinforcing members 500 and 600 are not separated strip shapes but form a unitary body in which each of the end units of the first and second chassis reinforcing members 500 and 600 are connected to each other. If the end units of the first and second chassis reinforcing members 500 and 600 were not connected, stresses would be concentrated on the disconnected corners. If the first and second chassis reinforcing members 500 and 600 form a unitary body, the strength of the chassis base assembly 400 increases.

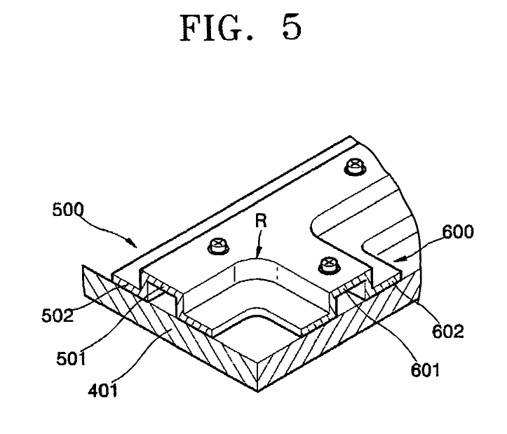

FIG. 5 is an enlarged view of region “B” in FIG. 4.

Referring to FIG. 5, the first chassis reinforcing member 500 includes a first rib 501 in a strip shape disposed along a horizontal direction of the main body unit 401 and a first flange 502 bent downward from both edges of the first rib 501. The first flange 502 can be attached to a surface of the main body unit 401.

The second chassis reinforcing member 600 includes a second rib 601 having a strip shape disposed along a vertical direction of the main body unit 401 and a second flange 602 bent downward from both edges of the second rib 601. The second flange 602 contacts the surface of the main body unit 401.

Both end units of the first chassis reinforcing member 500 are connected to inner sides of the second chassis reinforcing member 600 to form a unitary body, and both end units of the second chassis reinforcing member 600 are connected to inner sides of the first chassis reinforcing member 500 to form a unitary body. Also, the portion R where the first and second chassis reinforcing members 500 and 600 are connected to form a unitary body having a predetermined curvature.

The first and second chassis reinforcing members 500 and 600 connected to form a unitary body can be attached to the main body unit 401 by attaching one of the first and second ribs 501 and 601 or the first and second flanges 502 and 602 using an attaching means, such as screws.

A method of manufacturing the first and second chassis reinforcing members 500 and 600 connected to form a unitary body is described below.

A flat panel for forming the first and second chassis reinforcing members 500 and 600 having a strip shape is prepared. The first and second ribs 501 and 601 having a predetermined depth are formed using a drawing process. The drawing process is pushing the flat panel placed on a die using a punch by applying a predetermined external force to the punch.

Afterward, to form an outer shape of the first and second chassis reinforcing members 500 and 600, the flat panel on which the first and second ribs 501 and 601 are formed is processed using a blanking process or a notching process. Then, the manufacturing of the first and second chassis reinforcing members 500 and 600 is completed.

Next, lower surfaces of the first and second flanges 502 and 602 are arranged to contact the surface of the main body unit 401, and the first and second chassis reinforcing members 500 and 600 connected to form a unitary body are attached to a rear surface of the main body unit 401 using screws.

As described above, the chassis base assembly, the method of manufacturing the chassis base assembly, and the PDP assembly using the chassis base assembly according to the present invention have the following advantages.

First, the chassis base has a higher strength due to the chassis base reinforcing member attached to a rear surface thereof.

Second, since the horizontal and vertical reinforcing members are integrally formed in a drawing process, stress concentration in the corner areas of the chassis reinforcing members is prevented.

Third, the rib of the chassis reinforcing member has a uniform height at corners where the horizontal and vertical reinforcing members meet each other since the chassis reinforcing members are formed by a drawing process.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A chassis base assembly comprising:
a chassis base attached to a panel assembly adapted to display an image; and
a unitary chassis reinforcing member arranged on a surface of the chassis base.

2. The chassis base assembly of claim 1, wherein the unitary chassis reinforcing member comprises a plurality of connected strips arranged along horizontal and vertical directions of the chassis base.

3. The chassis base assembly of claim 2, wherein the unitary chassis reinforcing member comprises strip shaped ribs and flanges contacting an outer surface of the chassis base by extending downward from edges of the ribs.

4. The chassis base assembly of claim 1, wherein the unitary chassis reinforcing member comprises a drawn member.

5. A plasma display assembly comprising:
a panel assembly having a front panel and a rear panel facing the front panel;
a chassis base adapted to support the panel assembly;
a drawn unitary chassis reinforcing member attached to a surface of the chassis base;
a driving circuit unit attached to the chassis base;
a plurality of flexible printed cables each including one end thereof being electrically connected to respective electrode terminals of the panel assembly and another end thereof being electrically connected to a connector of the driving circuit unit, the plurality of flexible printed cables being adapted to transfer electrical signals therebetween; and
a case adapted to accommodate the panel assembly, the chassis base, the driving circuit unit, and the plurality of flexible printed cables.

6. The plasma display assembly of claim 5, wherein the unitary chassis reinforcing member comprises a plurality of connected strips arranged along horizontal and vertical directions of the chassis base.

7. The plasma display assembly of claim 6, wherein the unitary chassis reinforcing member comprises ribs protruded toward the driving circuit unit from an outer surface of the chassis base and flanges contacting an outer surface of the chassis base by extending from an edge of the ribs.

8. A method of manufacturing a chassis base assembly, the method comprising:
preparing a raw flat panel for forming the chassis reinforcing member;
forming ribs having a predetermined depth by processing the raw flat panel for forming the chassis reinforcing member using a drawing process; and
forming an outer shape of the chassis reinforcing member using a blanking process.

9. A method of manufacturing a chassis base assembly, the method comprising:
preparing a raw flat panel for forming the chassis reinforcing member;
forming ribs having a predetermined depth by processing the raw flat panel for forming the chassis reinforcing member using a drawing process; and
forming an outer shape of the chassis reinforcing member using a notching process.

10. The method of claim 8, wherein, the forming of the ribs having a predetermined depth by processing the raw flat panel using a drawing process includes connecting the chassis reinforcing members to each other to form a unitary body along horizontal and vertical directions of the chassis base.

11. The method of claim 9, wherein, the forming of the ribs having a predetermined depth by processing the raw flat panel using a drawing process includes connecting the chassis reinforcing members to each other to form a unitary body along horizontal and vertical directions of the chassis base.
